(19) United States
(12) Patent Application Publication
(10) Pub. No.: US 2026/0140229 A1
(43) Pub. Date: May 21, 2026

(54) COLLISION AVOIDANCE AND AWARENESS SYSTEMS AND METHODS WITH DYNAMIC OBJECT SIZE DETERMINATION

(71) Applicant: Caterpillar Paving Products Inc., Brooklyn Park, MN (US)

(72) Inventors: Matthew T. Hanson, St. Louis Park, MN (US); Sangameshwar Sonth, Garner, NC (US); John L. Marsolek, Watertown, MN (US)

(73) Assignee: Caterpillar Paving Products Inc., Brooklyn Park, MN (US)

(21) Appl. No.: 18/949,967

(22) Filed: Nov. 15, 2024

(51) Int. Cl. G01S 7/41; G01S 13/931

(52) U.S. Cl. CPC G01S 7/412; G01S 13/931

(57) ABSTRACT

A collision avoidance and awareness system (CAAS) includes a RADAR device and a controller. The RADAR device is configured to emit radio frequency (RF) signals and receive RF signals reflected off objects back to the RADAR device. The controller is communicatively connected to the RADAR device. The controller is configured to receive information from the RADAR device for a first RF signal reflected off an object. The information includes a first location of the object relative to the CAAS. The controller is configured to estimate a first size of the object based on the first location of the object and a first resolution of the RADAR device.

### TECHNICAL FIELD

This disclosure relates generally to systems and methods for dynamically detecting and determining the size of objects.

### BACKGROUND

Work machines of various types can include systems that detect objects in the vicinity of the work machine and estimate the size of such objects. Such collision avoidance and awareness systems, as they are sometimes called, can be used to warn, inhibit, brake, maneuver or otherwise modulate operation of work machines for various purposes, including, e.g. to avoid collisions with objects. Collision avoidance and awareness systems commonly employ a radio detection and ranging (RADAR) device/system to detect objects and their locations. RADAR devices emit radio frequency signals and detect signals reflected off of an object but are generally unable to measure the size of the object. As a result, a rough approximation of the size of the object may be calculated by the collision avoidance and awareness system for each signal reflection, e.g. as a circle of a predetermined diameter with the point of reflection lying at the center of the circle. Such roughly approximated object size determination may cause false positive and/or negative detections, and may lead to less than optimal modulation of work machine operation based on such determinations.

US Pub. No. 2016/0003939, entitled “VEHICLE RADAR CONTROL” discloses methods and systems for controlling a radar system of a vehicle. According to US Pub. No. 2016/0003939, one or more transmitters are configured to transmit radar signals. A plurality of receivers are configured to receive return radar signals after the transmitted radar signals are deflected from an object proximate the vehicle. A processor is coupled to the plurality of receivers, and is configured to generate a plurality of feature vectors based on the returned radar signals and generate a three dimensional representation of the object using the plurality of feature vectors.

### SUMMARY

In an example, a collision avoidance and awareness system (CAAS) includes a RADAR device and a controller. The RADAR device is configured to emit radio frequency (RF) signals and receive RF signals reflected off objects back to the RADAR device. The controller is communicatively connected to the RADAR device. The controller is configured to receive information from the RADAR device for a first RF signal reflected off an object. The information includes a first location of the object relative to the CAAS. The controller is configured to estimate a first size of the object based on the first location of the object and a first resolution of the RADAR device.

An example includes a method of detecting and avoiding objects in the vicinity of a work machine. The example method includes: receiving, by a controller of a collision avoidance and awareness system (CAAS) of the work machine, information from a RADAR device of the CAAS for a first RF signal reflected off an object, the information including a first location of the object relative to the work machine; and estimating, by the controller, a first size of the object based on the first location of the object and a first resolution of the RADAR device.

These and other examples and features of the present devices, systems, and methods will be set forth in part in the following Detailed Description. This overview is intended to provide a summary of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 schematically depicts a work machine including an example collision avoidance and awareness system (CAAS) in accordance with this disclosure.

FIG. 2 schematically depicts another work machine including an example collision avoidance and awareness system (CAAS) in accordance with this disclosure.

FIGS. 3A-3C schematically depict another work machine including an example collision avoidance and awareness system (CAAS) dynamically estimating the size of objects as the work machine travels.

FIG. 4 is flow chart depicting an example method in accordance with this disclosure.

### DETAILED DESCRIPTION

Prior collision avoidance and awareness systems commonly determine a rough approximation of the size of objects as the area of a circle of a predetermined diameter (or other shaped bounding box with a predetermined major dimension, e.g., square or rectangle with predetermined length or width) for each signal reflection from a RADAR device of the CAAS. Prior systems may monitor object location over time, i.e. track the object as the machine and/or object locations change relative to one another. However, the size estimation at these different locations may generally remain the same. The predetermined diameter used to roughly estimate the size of an object off of which RF signal(s) of the RADAR device are reflected may be, e.g., a lower limit of the resolution of the RADAR device in such prior systems.

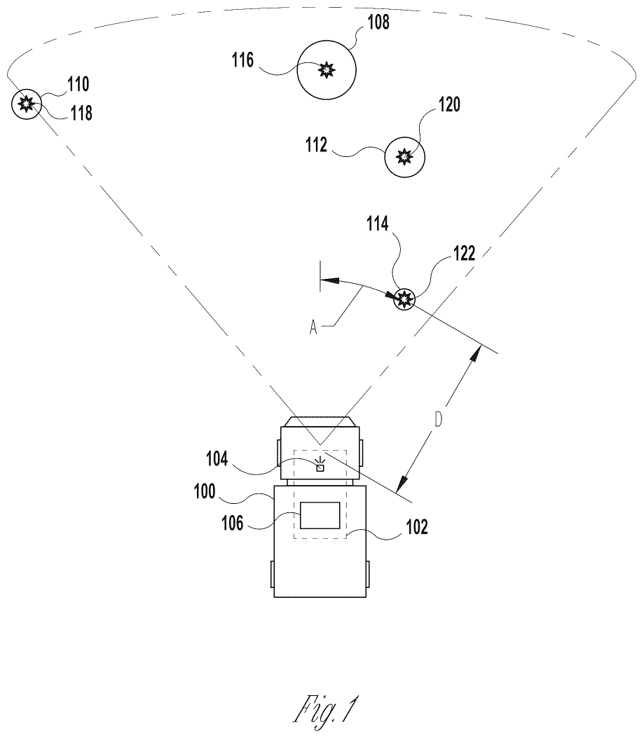

FIG. 1 depicts work machine 100 including example collision avoidance and awareness system (CAAS) 102 in accordance with this disclosure. Work machine 100 can include a variety of types of work machines related to various industries, including, as examples, construction, agriculture, forestry, transportation, material handling, waste management, and so on. Work machine 100 can include, for example, a paving machine, cold planer, wheel loader, grader, scraper, dozer, excavator, compactor, material haulers like dump trucks, along with other example machine types. Independent of type, work machine 100 may be an operator-controlled, autonomous, or semi-autonomous machine.

Example CAAS 102 can include RADAR device(s) 104 and controller 106. CAAS 102 can be employed for manual, semi-autonomous, or autonomous modulation of work machine 100 operation for various purposes, including, e.g. to avoid collisions with objects. CAAS 102 in accordance with examples of this disclosure can provide a more robust solution with finer resolutions than prior systems, which may be advantageous for various applications, including, e.g., autonomous and semi-autonomous work machine control.

CAAS 102 is configured to actively estimate the size of detected objects rather than assigning a standard/pre-determined size to all detected objects. For example, CAAS 102 is configured to estimate the size of a detected object based on the location of the object relative to work machine 100 and the resolution of RADAR device 104 at the object location. The resolution of RADAR device 104 varies as a function of a location of reflected signals relative to the RADAR device, which, in the context of CAAS 102 corresponds to the location of the object relative to work machine 100.

CAAS 102 is configured to detect objects at different resolutions (estimated sizes) depending upon the location of the object relative to work machine 100. For example, work machine 100 is in the vicinity of first object 108, second object 110, third object 112, and fourth object 114. Each of first object 108, second object 110, third object 112, and fourth object 114 is detected by RADAR device 104 by signals reflected back to RADAR device 104, which are schematically indicated in FIG. 1 as first, second, third, and fourth points 116, 118, 120, and 122.

Each of first object 108, second object 110, third object 112, and fourth object 114 is at a different location relative to work machine 100, which affects the resolution at which RADAR device 104 of CAAS 102 can detect. For example, each of objects 108, 110, 112, and 114 are at a distance, D, and bearing angle, A to work machine 100 (depicted in FIG. 1 for object 114). Bearing angle as used in examples of this disclosure can be the angle between an axis along the trajectory of the work machine and the object, as depicted in FIG. 1 for fourth object 114.

In examples, RADAR device 104 is configured to emit radio frequency (RF) signals and receive RF signals reflected off objects back to the RADAR device, e.g., reflected off first object 108, second object 110, third object 112, and fourth object 114. RADAR device 104 and controller 106 of CAAS 102 are communicatively connected to one another. RADAR device 104 is configured to capture information indicative of a number of parameters of detected objects including the location of the objects, which can include, e.g., distance and bearing angle. In examples, controller 106 of CAAS 102 receives information from RADAR device 104 for each RF signal reflected off an object. The RADAR signal information received by controller 106 includes the location of each object relative to work machine 100.

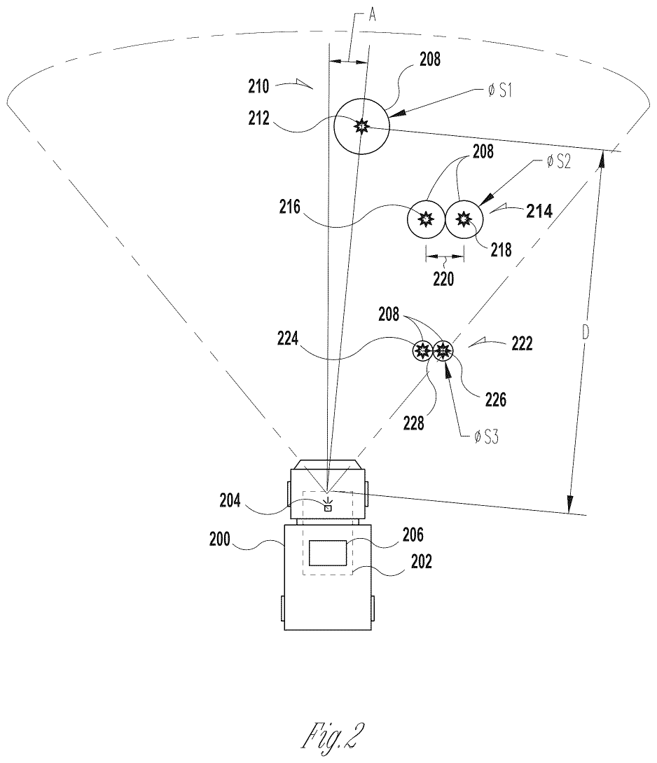

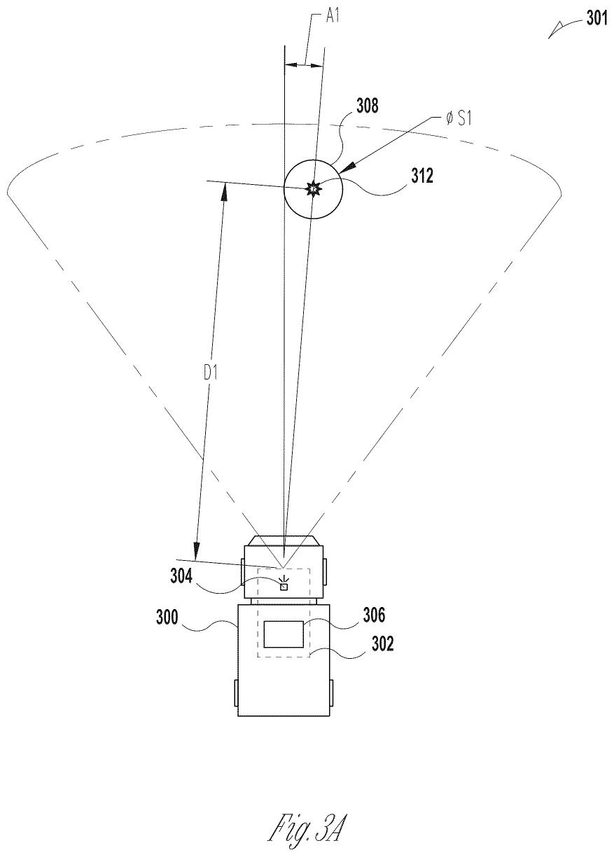

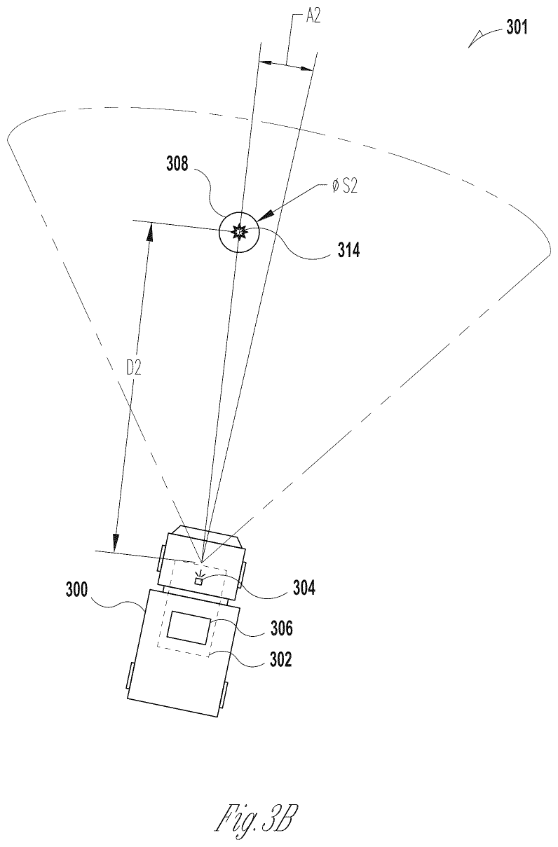

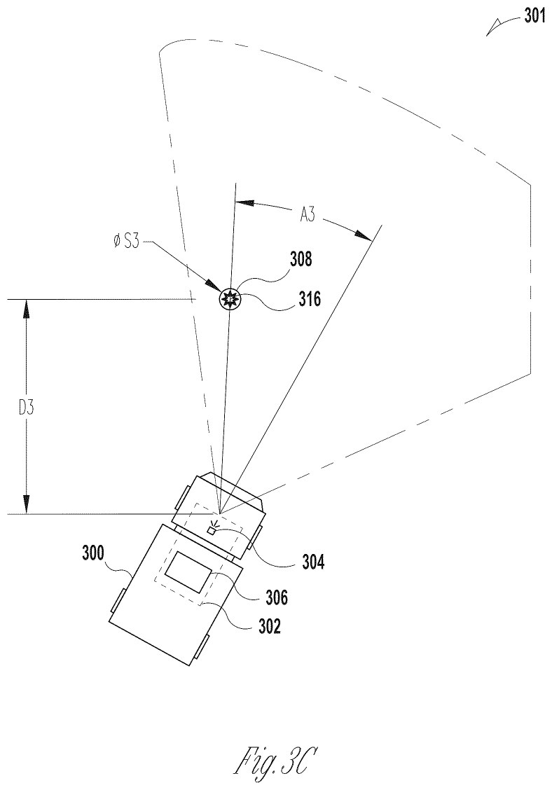

As will be described in more detail with reference to the examples of FIGS. 2 and 3A-3D, controller 106 of CAAS 102 is configured to estimate a size of each of first object 108, second object 110, third object 112, and fourth object 114 based on the location of the object and the resolution of RADAR device 104, which varies as a function of/is dependent upon the location of detected objects. Thus, as schematically illustrated in FIG. 1, RADAR device 104 of CAAS 102 detects each of first object 108, second object 110, third object 112, and fourth object 114 at different resolutions depending upon the location of the object relative to work machine 100 and based thereon controller 106 estimates each of the four objects as a different size.

FIG. 2 depicts work machine 200 including example collision avoidance and awareness system (CAAS) 202 in accordance with this disclosure. As described with the example of FIG. 1, work machine 200 can include a variety of types of work machines. Example CAAS 202 can include RADAR device 204 and controller 206. CAAS 202 can be employed for manual, semi-autonomous, or autonomous modulation of work machine 200 operation for various purposes, including, e.g. to avoid collisions with object(s) 208. CAAS 202 is depicted in the example of FIG. 2 detecting and estimating the size of object(s) 208 at different locations relative to CAAS 202 and work machine 200.

CAAS 202 is configured to detect objects at different resolutions (estimated sizes) depending upon the location of the object relative to work machine 200. For example, object(s) 208 are depicted in the example of FIG. 2 at different locations relative to work machine 200, which affects the resolution at which RADAR device 204 of CAAS 202 can detect. As described with reference to the example of FIG. 1, the location of objects detected by RADAR device 104 can include, e.g., a distance, D, and bearing angle, A to work machine 200, and the resolution of RADAR device 204 of CAAS 202 may vary as a function of each of these parameters of object(s) 208 in the vicinity of work machine 200. For example, at greater distances, D, or smaller bearing angles, A, the resolution of RADAR device 204 may be less than at smaller distances or larger bearing angles. The example of FIG. 2 depicts this variation of the resolution of RADAR device 204 for different locations, e.g. distances, D, and bearing angles, A of object(s) 208.

At a first position 210, object(s) 208 are at the greatest distance, D, and the smallest bearing angle, A to work machine 200. At first position 210, RADAR device 204 receives a single reflected signal 212 associated with object(s) 208. In an example, controller 206 may estimate the size of object(s) 208 at the first position as S1, which may be a predetermined rough size estimate for all detected objects at locations of lowest resolution of RADAR device 204. For example, controller 206 may estimate the size of object(s) 208 at the first position as the area of a circle of S1 diameter with S1 equal to about 1 meter (3.28 ft).

At a second position 214, object(s) 208 are at a lesser distance and larger bearing angle relative to work machine 200 than first position 210. At second position 214, RADAR device 204 receives two reflected signals 216, 218 associated with object(s) 208. It is noted that in the example of FIG. 2, object(s) 208 are the same object or multiple objects at different positions relative to work machine 200. Additionally, from the perspective of CAAS 202 and RADAR device 204, it does not matter if object(s) 208 are one or multiple objects in the vicinity of work machine 200.

Referring again to object(s) 208 in second position 214, RADAR device 204 receives two reflected signals 216, 218 associated with object(s) 208. The information obtained by RADAR device 204 for each of signals 216, 218 can include the distance and bearing angle of each signal relative to work machine 200. Based on this information, CAAS 202, e.g. controller 204 can determine a distance between the two signals, 216, 218. The resolution of RADAR devices can be affected by/dependent upon a number of different factors. In examples, RADAR device location dependent resolution for example CAAS in accordance with this disclosure may be expressed as the signal separability of the RADAR device at different locations relative to the work machine to which the CAAS and RADAR device are connected. The example of FIG. 2 is illustrating signal separability of RADAR device 204 at different locations relative to work machine 200. At second position 214, the signal separability of RADAR device is equal to the distance 220 between the two signals 216, 218 reflected off object(s) 208 at the second position/location.

In examples, controller 206 receives information from RADAR device 204 for of RF signals 216, 218 reflected off object(s) 208 at second position 214. The information received by controller 206 from RADAR device 204 includes the location of signals 216, 218, which can include a distance and a bearing angle of each signal relative to work machine 200. Controller 206 then estimates the size S2 of object(s) 208 based on the location of signals 216, 218, and the resolution of RADAR device 204 at these locations. In an example, controller 206 estimates size S2 of the object(s) as an area of a circle with a diameter equal to the signal separability 220 of RADAR device 204 at second location 214 of object(s) 208. As RADAR device 204 received two signals 216, 218 at second location 214, controller may map object(s) 208 as two circles with diameter equal to distance between signals/signal separability 220, as depicted in the example of FIG. 2.

At a third position 222, object(s) 208 are at a lesser distance and larger bearing angle relative to work machine 200 than both first position 210 and second position 214. At third position 222, RADAR device 204 receives two reflected signals 224, 226 associated with object(s) 208. The information obtained by RADAR device 204 for each of signals 224, 226 can include the distance and bearing angle of each signal relative to work machine 200.

In examples, controller 206 receives information from RADAR device 204 for of RF signals 224, 226 reflected off object(s) 208 at third position 222. The information received by controller 206 from RADAR device 204 includes the location of signals 224, 226, which can include a distance and a bearing angle of each signal relative to work machine 200. Controller 206 then estimates the size S3 of object(s) 208 based on the location of signals 224, 226, and the resolution of RADAR device 204 at these locations. In an example, controller 206 estimates size S3 of object(s) 208 as an area of a circle with a diameter equal to the signal separability 228 of RADAR device 204 at third location 222 of object(s) 208. As RADAR device 204 received two signals 226, 228 at second location 214, controller may map object(s) 208 as two circles with diameter equal to distance between signals/signal separability 220. As depicted in the example of FIG. 2, the resolution of RADAR device 204 has increased (signal separability has progressively gotten smaller) as the distance of object(s) 208 relative to work machine 200 has lessened and the bearing angle of the objects has increased from first to second to third positions 210, 214, 222, respectively.

In some examples according to this disclosure, the location dependent resolution of a RADAR device of a CAAS can be predetermined prior to employing the CAAS with the RADAR device on a machine in the field. For example, the resolution of the RADAR device at different locations relative to the device (and by extension relative to the work machine to which the device is connected) can be numerically/experimentally determined prior to use and stored electronically in a look-up table, database, or other electronic record that may be stored and read by, e.g., a controller of the CAAS.

Thus, in the example of FIG. 2 at third location 222, controller 206 receives information from RADAR device 204 for of RF signals 224, 226 reflected off object(s) 208 at third position 222. The information received by controller 206 from RADAR device 204 includes the location of signals 224, 226, which can include a distance and a bearing angle of each signal relative to work machine 200. Controller 206 then estimates the size S3 of object(s) 208 based on the location of signals 224, 226, and the resolution of RADAR device 204 at these locations. In an example, controller 206 estimates size S3 of object(s) 208 using a look-up table that maps a plurality of resolutions of RADAR device 204 at a plurality of locations relative to work machine 200. For example, controller 206 reads the look-up table to determine the resolution of RADAR device 204 at the locations of signals 224, 226 and estimates size S3 of object(s) 208 as an area of a circle with a diameter equal to the retrieved resolution of RADAR device 204 at third location 222 of object(s) 208. As described above, the diameter of the circles representing object(s) 208 and the resolution of RADAR device 204 at third location 222 can be equal or otherwise correlated to the signal separability 228 at that location.

### INDUSTRIAL APPLICABILITY

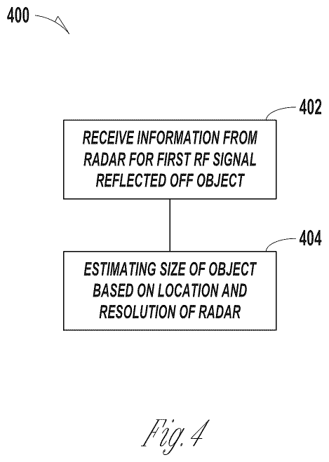

FIGS. 3A-3C schematically depict another work machine including an example collision avoidance and awareness system (CAAS) dynamically estimating the size of objects as the work machine travels. And FIG. 4 is a flowchart depicting example method 400 in accordance with examples of this disclosure. Example method 400 includes receiving information from a RADAR device for a first RF signal reflected off an object, the information including a first location of the object relative to a work machine (402), and estimating a first size of the object based on the first location of the object and a first resolution of the RADAR device (402).

Referring to FIGS. 3A-3C and FIG. 4, in operation, example work machine 300 is traveling, e.g., on worksite 301 in the vicinity of one or more objects, which the machine may need to avoid via manual operator, or autonomous or semi-autonomous control. Work machine 300 includes collision avoidance and awareness system (CAAS) 302 in accordance with this disclosure. As described with the examples of FIGS. 1 and 2, work machine 300 can include a variety of types of work machines. Example CAAS 302 can include RADAR device 304 and controller 306. CAAS 302 can be employed for manual, semi-autonomous, or autonomous modulation of work machine 300 operation for various purposes, including, e.g. to avoid collisions with object(s) 308.

CAAS 302 is configured to detect objects at different resolutions (estimated sizes) depending upon the location of the object relative to work machine 300. In FIG. 3A, work machine 300 is approaching object(s) 308 traveling forward and straight on worksite 301. Object(s) 308 are at a first location relative to work machine 300 in FIG. 3A, which corresponds to a first resolution of RADAR device 304 of CAAS 302. The relative location of object(s) 308 to work machine 300 can be characterized in different ways. In an example, RADAR device and/or controller 306 are configured to characterize the signal information of RADAR device associated with object(s) 308 as including, e.g., a distance, D, and bearing angle, A to work machine 300, and the resolution of RADAR device 304 of CAAS 302 may vary as a function of each of these parameters of object(s) 308 in the vicinity of work machine 300.

In FIG. 3A, object(s) 308 are at a first location relative to work machine 300 as the machine travels on worksite 301. In examples, object(s) 308 are at a first distance, D1, and first bearing angle, A1 to work machine 300. As work machine 300 travels on worksite 301, RADAR device 204 receives a reflected signal 312 associated with object(s) 308 and communicates information associated with signal 312 to controller 306. In an example, controller 306 may estimate a first size of object(s) 308 as S1.

Depending, for example, on first distance, D1, and first bearing angle, A1, the first size of object(s) 308, S1 estimated by controller 306 may be a predetermined rough size estimate for all detected objects at locations of lowest resolution of RADAR device 304. For example, controller 306 may estimate the size of object(s) 308 at the first position as the area of a circle of S1 diameter with S1 equal to about 1 meter (3.28 ft).

In examples, controller 306 of CAAS 302 may estimate the first size, S1 of object(s) 308 based on the signal separability of RADAR device 304 at the first location, e.g. first distance, D1, and first bearing angle, A1, of object(s) 308. For example, controller 306 receives information from RADAR device 304 for first RF signal 312 reflected off object(s) 308 in location of FIG. 3A. The information received by controller 306 from RADAR device 204 includes the location of signal 312, which can include a distance and a bearing the signal relative to work machine 300. Controller 306 then estimates first size S1 of object(s) 308 based on the location of first signal 312, and the resolution of RADAR device 304 at the location of FIG. 3A, e.g., at first distance, D1, and first bearing angle, A1.

In an example, controller 306 estimates first size S1 of object(s) 308 using a look-up table that maps a plurality of resolutions of RADAR device 304 at a plurality of locations relative to work machine 300. For example, controller 306 reads the look-up table to determine the resolution of RADAR device 304 at the location of first signal 312/object(s) 308 in FIG. 3A, e.g., at first distance, D1, and first bearing angle, A1. Controller 306 then estimates first size S1 of object(s) 308 as an area of a circle with a diameter equal to the retrieved resolution of RADAR device 304, which can be or correspond to the signal separability of RADAR device 304 at first distance, D1, and first bearing angle, A1 relative to work machine 300.

In FIG. 3B, work machine 300 is continuing to approach object(s) 308 traveling forward closer to the objects and has turned to the right (from the perspective of the view of FIG. 3B). Object(s) 308 are at a second location relative to work machine 300 in FIG. 3B, which corresponds to a second resolution of RADAR device 304 of CAAS 302. In FIG. 3B, the second location of object(s) 308 relative to work machine 300 includes a second distance, D2, and second bearing angle, A2. As work machine 300 travels on worksite 301, RADAR device 304 receives a reflected second signal 314 associated with object(s) 308 and communicates information associated with second signal 314 to controller 306.

In examples, controller 306 of CAAS 302 estimates second size, S2 of object(s) 308 based on the resolution (which may be signal separability) of RADAR device 304 at the second location, e.g. second distance, D2, and second bearing angle, A2 of object(s) 308. For example, controller 306 receives information from RADAR device 304 for second RF signal 314 reflected off object(s) 308 in location of FIG. 3B. The information received by controller 306 from RADAR device 304 includes the location of second signal 314, which can include a distance and a bearing the signal relative to work machine 300. Controller 306 then estimates second size S2 of object(s) 308 based on the location of second signal 314, and the resolution of RADAR device 304 at the location of FIG. 3B, e.g., at second distance, D2, and second bearing angle, A2.

In an example, controller 306 estimates second size S2 of object(s) 308 using a look-up table that maps a plurality of resolutions of RADAR device 304 at a plurality of locations relative to work machine 300. For example, controller 306 reads the look-up table to determine the resolution of RADAR device 304 at the location of second signal 314 / object(s) 308 in FIG. 3B, e.g., at second distance, D2, and second bearing angle, A2. Controller 306 then estimates second size S2 of object(s) 308 as an area of a circle with a diameter equal to the retrieved resolution of RADAR device 304, which can be or correspond to the signal separability of RADAR device 304 at second distance, D2, and second bearing angle, A2 relative to work machine 300.

In FIG. 3C, work machine 300 is continuing to approach object(s) 308 traveling forward closer to the objects and has turned further to the right (from the perspective of the view of FIG. 3C). Object(s) 308 are at a third location relative to work machine 300 in FIG. 3C, which corresponds to a third resolution of RADAR device 304 of CAAS 302. In FIG. 3C, the third location of object(s) 308 relative to work machine 300 includes a third distance, D3, and third bearing angle, A3. As work machine 300 travels on worksite 301, RADAR device 304 receives a reflected third signal 316 associated with object(s) 308 and communicates information associated with third signal 316 to controller 306.

In examples, controller 306 of CAAS 302 estimates third size, S3 of object(s) 308 based on the resolution (which may be signal separability) of RADAR device 304 at the third location, e.g. third distance, D3, and third bearing angle, A3 of object(s) 308. For example, controller 306 receives information from RADAR device 304 for third RF signal 316 reflected off object(s) 308 in location of FIG. 3C. The information received by controller 306 from RADAR device 304 includes the location of third signal 316, which can include a distance and a bearing the signal relative to work machine 300. Controller 306 then estimates third size S3 of object(s) 308 based on the location of third signal 316, and the resolution of RADAR device 304 at the location of FIG. 3C, e.g., at third distance, D3, and third bearing angle, A3.

In an example, controller 306 estimates third size S3 of object(s) 308 using a look-up table that maps a plurality of resolutions of RADAR device 304 at a plurality of locations relative to work machine 300. For example, controller 306 reads the look-up table to determine the resolution of RADAR device 304 at the location of third signal 316/object(s) 308 in FIG. 3C, e.g., at third distance, D3, and third bearing angle, A3. Controller 306 then estimates third size S3 of object(s) 308 as an area of a circle with a diameter equal to the retrieved resolution of RADAR device 304, which can be or correspond to the signal separability of RADAR device 304 at third distance, D3, and third bearing angle, A3 relative to work machine 300.

In examples the first, second, and third sizes, S1, S2, S3 of object(s) estimated by controller 306 of CAAS 302 are different. In an example, first size, S1 is larger than second size S2, and second size, S2 is larger than third size, S3.

Controllers in examples according to this disclosure, e.g., 106, 206, and 306 can include one or more controllers located on or remote from a machine including an associated CAAS. For example, controllers in accordance with examples of this disclosure can be included in or separate from a machine. Examples according to this disclosure may include multiple controllers working in conjunction with each other to execute functions attributed to the controller(s). In examples, controller(s) can be part of or included in an electronic control unit ECU of a work machine.

Controller(s), ECUs, etc. included in examples according to this disclosure can be configured to communicate with one another and with other components of the work machine via various wired or wireless communications technologies and components using various public and/or proprietary standards and/or protocols. Examples of transport mediums and protocols for electronic communication between components of the work machine include Controller Area Network (CAN) protocol, Ethernet, Transmission Control Protocol/Internet Protocol (TCP/IP), IEEE 802.11 or Bluetooth, or other standard or proprietary transport mediums and communication protocols.

In some examples, controller(s) can be included in an ECU of a machine. An electronic control unit (ECU) can be an embedded system that controls various aspects of machine operation. Types of ECUs include Electronic/Engine Control Module, Powertrain Control Module, Transmission Control Module, Brake Control Module, Suspension Control Module, among other examples. In the case of industrial, construction, and other heavy machinery, example ECUs can also include an Implement Control Module associated with one or more implements connected to and operable from the machine. These electronic modules/units can be communicatively connected and configured to send and receive data, sensor or other digital and/or analog signals, and other information between the various ECUs of the machine. Additionally, functions attributed to a controller, ECU, and the like, can be distributed among multiple devices.

Controller(s), whether onboard and/or separate from a machine, can include software, hardware, and combinations of hardware and software configured to execute a number of functions attributed to the components in the disclosed examples. Such controllers in examples according to this disclosure can be an analog, digital, or combination analog and digital controller including a number of components. As examples, the controller(s) can include integrated circuit boards or ICB(s), printed circuit boards PCB(s), processor(s), data storage devices, switches, relays, etcetera. Examples of processors can include any one or more of a microprocessor, a controller, a digital signal processor (DSP), an application specific integrated circuit (ASIC), a field-programmable gate array (FPGA), or equivalent discrete or integrated logic circuitry.

Controller(s), ECUs and other electronic controls in examples according to this disclosure can include storage media to store and/or retrieve data or other information, for example, signals from sensors. Examples of non-volatile storage devices include magnetic hard discs, optical discs, floppy discs, flash memories, or forms of electrically programmable memories (EPROM) or electrically erasable and programmable (EEPROM) memories. Examples of volatile storage devices include random access memories (RAM), dynamic random access memories (DRAM), static random access memories (SRAM), and other forms of volatile storage devices. The data storage devices can be used to store program instructions for execution by processor(s) of, for example, the controller(s).

Additionally, controller(s), ECUs and other electronic controls in examples according to this disclosure can include additional digital and/or analog components, including transmitters, receivers, transceivers, positioning systems, e.g., Global Positioning Systems, as examples. In an example, controller(s) and/or ECUs can include GPS from which/by which the controller and/or ECU can send and receive data indicative of machine or other element position on a worksite, as well as store and reference 2D or 3D maps of the worksite.

In the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific examples. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific examples. However, the benefits, advantages, solutions to problems, and any feature(s) that may cause any benefit, advantage, or solution to occur or become more pronounced are not to be construed as a critical, required, or essential feature of any or all the claims. Moreover, the particular examples disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular examples disclosed above may be altered or modified and all such variations are considered within the scope of the disclosed subject matter. Accordingly, the protection sought herein is as set forth in the claims below.

What is claimed is:

1. A collision avoidance and awareness system (CAAS), the CAAS comprising:
a RADAR device configured to emit radio frequency (RF) signals and receive RF signals reflected off objects back to the RADAR device; and
a controller communicatively connected to the RADAR device, the controller configured to:
receive information from the RADAR device for a first RF signal reflected off an object, the information including a first location of the object relative to the CAAS; and
estimate a first size of the object based on the first location of the object and a first resolution of the RADAR device.

2. The CAAS of claim 1, wherein resolution of the RADAR device varies as a function of location of objects relative to the CAAS.

3. The CAAS of claim 2, wherein resolution of the RADAR device varies as a function of bearing angle and distance of objects relative to the CAAS.

4. The CAAS of claim 1, wherein the controller is configured to estimate the first size of the object using a look-up table that maps a plurality of resolutions of the RADAR device at a plurality of locations relative to the CAAS.

5. The CAAS of claim 1 connected to a work machine.

6. The CAAS of claim 5, wherein the controller is configured to modulate operation of the work machine based on one or both of the first location and the estimated first size of the object.

7. The CAAS of claim 6, wherein the controller is configured to control an output device of the work machine to indicate one or both of the first location and the estimated first size of the object to an operator.

8. The CAAS of claim 6, wherein the controller is configured to modulate one or both of a speed and a direction of travel of the work machine based on one or both of the first location and the estimated first size of the object.

9. The CAAS of claim 6, wherein the controller is configured to control a brake system of the work machine to stop movement of the work machine based on one or both of the first location and the estimated first size of the object.

10. The CAAS of claim 1, wherein resolution of the RADAR device varies as a function of location of objects relative to the CAAS, and wherein the controller is configured to:
receive information from the RADAR device for a second RF signal reflected off the object, the information including a second location of the object relative to the CAAS; and
estimate a second size of the object based on the second location of the object and a second resolution of the RADAR device.

11. The CAAS of claim 10, wherein the estimated second size of the object and the second resolution of the RADAR device are different than the estimated first size of the object and the first resolution of the RADAR device.

12. The CAAS of claim 10, wherein the estimated second size of the object is smaller than the estimated first size of the object.

13. The CAAS of claim 10, wherein the estimated second size of the object is larger than the estimated first size of the object.

14. The CAAS of claim 1, wherein:
resolution of the RADAR device includes a signal separability of the RADAR device;
the signal separability of the RADAR device is indicative of a minimum distance between two RF signals reflected back to the RADAR device; and
the signal separability of the RADAR device varies as a function of bearing angle and distance of objects relative to the CAAS.

15. The CAAS of claim 14, wherein the controller is configured to estimate the first size of the object as an area of a circle with a diameter equal to the signal separability of the RADAR device at the first location of the object.

16. The CAAS of claim 15, wherein the first location of the object includes a first bearing angle and a first distance of the object relative to the CAAS.

17. A method of detecting and avoiding objects in the vicinity of a work machine, the method comprising:
receiving, by a controller of a collision avoidance and awareness system (CAAS) of the work machine, information from a RADAR device of the CAAS for a first RF signal reflected off an object, the information including a first location of the object relative to the work machine; and
estimating, by the controller, a first size of the object based on the first location of the object and a first resolution of the RADAR device.

18. The method of claim 17, further comprising:
receiving, by the controller, information from the RADAR device for a second RF signal reflected off the object, the information including a second location of the object relative to the work machine; and
estimating, by the controller, a second size of the object based on the second location of the object and a second resolution of the RADAR device.

19. The method of claim 18, wherein the second size is different than the first size.

20. The method of claim 16, further comprising modulating one or both of a speed and a direction of travel of the work machine based on one or both of the first location and the estimated first size of the object.
